(19) United States
(12) Patent Application Publication
(10) Pub. No.: US 2026/0189115 A1
(43) Pub. Date: Jul. 2, 2026

(54) ADDING ROTORS IN SERIES

(71) Applicant: NextPower360 Co., Leicester, NC (US)

(72) Inventor: Benedetto Anthony IACOVELLI, Leicester, NC (US)

(21) Appl. No.: 19/256,967

(22) Filed: Jul. 1, 2025

Related U.S. Application Data
(60) Provisional application No. 63/666,535, filed on Jul. 1, 2024.

(51) Int. Cl. H02K 21/36

(52) U.S. Cl. CPC H02K 21/36

(57) ABSTRACT

A homopolar dynamoelectric machine includes a hollow tube with an empty center, stator layers spaced radially apart from one another and housed within the hollow tube, rotor layers provided within the hollow tube alternating between adjacent ones of the stator layers and rotatable due to a magnetic field generated by the stator layers, electrical connectors which electrically connect axial ends of adjacent ones of the rotor layers in series, parallel, or a combination of series and parallel, and at least one flux return mitigation assembly that interacts with flux of the magnetic field generated by the stator layers. The rotor layers and the stator layers are integrally connected to be rotatable together about a central axis of the hollow tube.

### CROSS-REFERENCE TO RELATED APPLICATIONS

The present application claims domestic priority to 63/666,535, filed on Jul. 1, 2024, the entire contents of which are hereby incorporated herein by reference.

### BACKGROUND OF THE INVENTION

### 1. Field of the Invention

The present invention relates to novel structures and systems for improvements to generators and motors. More specifically, the present invention relates to drum or disk homopolar machines which are able to be used to increase a power output per volume, field strength per magnet mass, and the voltage.

### 2. Description of the Related Art

The most commonly understood homopolar disk generator employs a disk spinning in, and at right angles to, a magnetic field. Often, that field is created by permanent magnets stationed on either side of the disc. Because of the Faraday paradox, the magnets can be stationary or spinning about the same axis as the disk and the unit still creates the same amount of power. Essentially the field can be thought of as stationary whether the magnets are stationary or spinning about their North/South axis.

From a physics standpoint, but for a single fatal flaw in the voltage to current ratio of the power output, homopolar electrical machines are nearly ideal for power production, low cost of manufacture, and operational reliability. The magnet poles are closer together, with a direct, straight flux path, creating a much stronger field. The field is perfectly oriented and does not bulge or cross-react as it does in conventional machines.

### SUMMARY OF THE INVENTION

To overcome the problems described above, example embodiments of the present invention provide new dynamoelectric motor and generator systems and structures that instantly and constantly adapt to the variability of an input or output rotational speed. There is no need for heavy, bulky, and costly silicon steel laminations in the example embodiments of the present disclosure. The percent of the volume of, for example, the generator that is actively experiencing voltage induction is orders of magnitude higher than in conventional designs. The interaction between the rotor and the stationary magnetic field involves the entire rotor cutting all field lines simultaneously at any RPM above zero so that the generator starts creating power as soon as the rotor begins to move. The entire rotor is bathed in a perfectly ordered field such that the flux lines are always perpendicular to the motion of the rotor. The rotor can be entirely immersed in this perfectly ordered, and very powerful field throughout its entire circumference, length and 360 degree rotation. No conventional generator comes close to these advantages.

According to an example embodiment of the present invention, a homopolar dynamoelectric machine includes a hollow tube with an empty center, stator layers spaced radially apart from one another and housed within the hollow tube, rotor layers provided within the hollow tube alternating between adjacent ones of the stator layers and rotatable due to a magnetic field generated by the stator layers, electrical connectors that electrically connect axial ends of adjacent ones of the rotor layers in series, parallel, or a combination of series and parallel, and at least one flux return mitigation assembly that interacts with flux of the magnetic field generated by the stator layers. The rotor layers and the stator layers are integrally connected to be rotatable together about a central axis of the hollow tube.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a perspective view of an axial end of a Faraday drum homopolar machine according to an example embodiment of the present invention.

FIG. 2 shows a cross section of a cylindrical machine according to an example embodiment of the present invention.

FIG. 3 shows a cross section of a cylindrical machine according to an example embodiment of the present invention.

FIG. 4a shows a perspective view of an axial end of a Faraday drum homopolar motor according to an example embodiment of the present invention.

FIG. 4b shows a cross section of a cylindrical machine according to an example embodiment of the present invention.

FIG. 5 shows a cross section of a cylindrical machine according to an example embodiment of the present invention.

FIG. 6 shows a cross section of a cylindrical machine according to an alternate example embodiment of the present invention.

FIG. 7 shows radial and axial cross sections of a cylindrical machine according to another alternate example embodiment of the present invention.

FIG. 8a shows a perspective view of a Faraday drum homopolar motor according to an example embodiment of the present invention.

FIG. 8b shows a perspective view of a Faraday drum homopolar motor according to an example embodiment of the present invention.

### DETAILED DESCRIPTION OF EXAMPLE EMBODIMENTS

Example embodiments of the present invention will now be described with reference to the Drawings.

Example embodiments of the present invention are usable for dynamoelectric machines including electric motor applications as well as generator applications (e.g., the example embodiments of the present invention are applicable for any type of dynamoelectric machine). For the purpose of this disclosure, the focus will be on drum and disk type example embodiments of homopolar type generators and motors, but the principles and techniques according to example embodiments disclosed herein apply to all homopolar/designs in ways that are clear to those skilled in the art.

Homopolar generators and motors generally require sliding contacts to collect the energy induced in the rotors. Unfortunately, homopolar generators usually produce power that, while having very high amperage, also has such a deleteriously low voltage that the electrical resistance from sliding contacts offsets a significant percentage of the power made in the generator. The measured output beyond the sliding contacts may be only a small fraction of the power that the generator can produce internally before the resistance of the sliding contact. For example, a typical assembly may make 125,000 amps but only ¼th of a volt. If the contact resistance drops voltage by ⅕th of a volt only 1/20th of the power is expressed. Sliding contacts have many other disadvantages, including wear, maintenance requirements and they give off electrically conductive dust inside of an electrical machine.

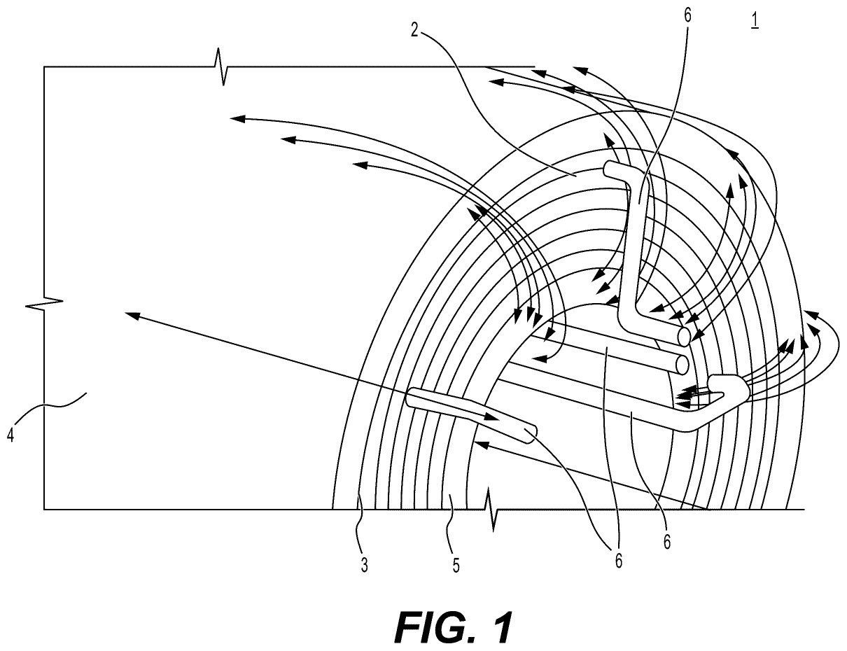

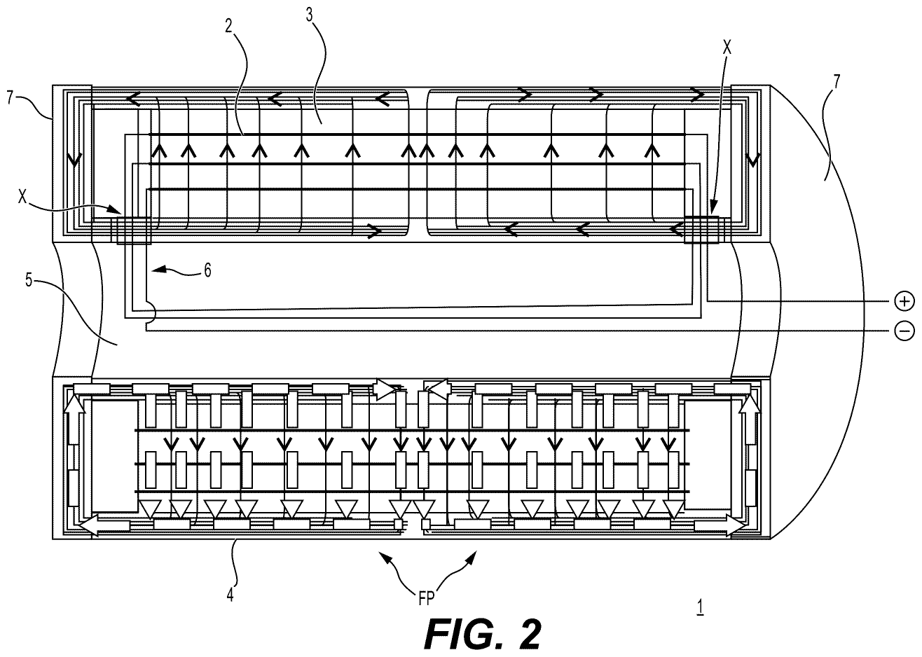

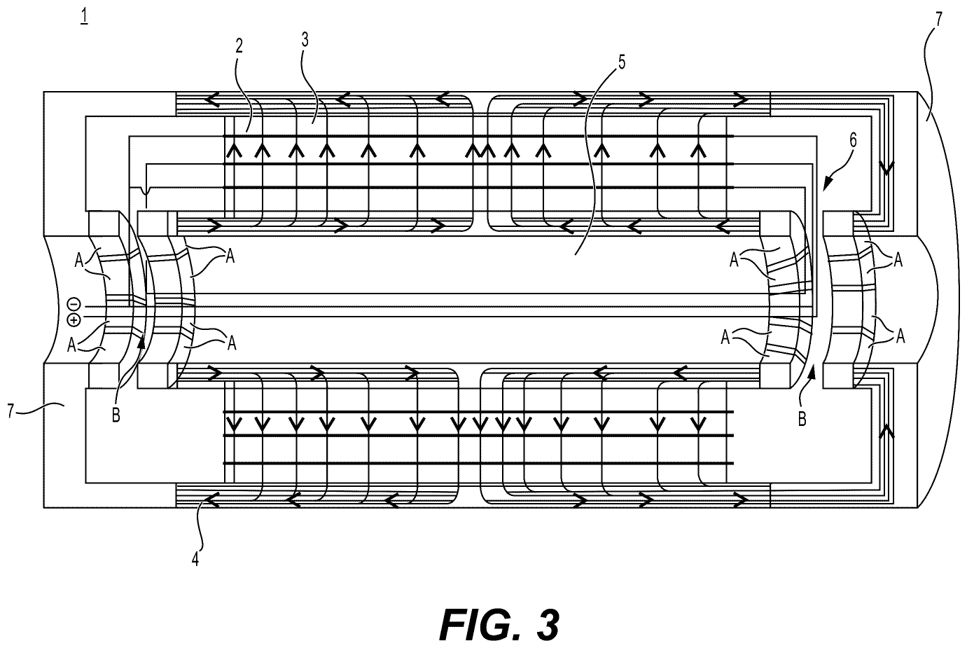

FIG. 1 shows an example embodiment of a novel Faraday paradox drum homopolar machine 1 according to an example embodiment of the present invention. The Faraday paradox drum homopolar machine 1 preferably includes, for example, five cylindrical rotors 2 sandwiched between six magnet layers 3 (e.g., “stator” layers) that define a stationary radial magnetic field, because of the Faraday paradox, the magnetic field functions as if it were stationary even when the magnet layers 3 are rotating together with the cylindrical rotors 2. The cylindrical rotors 2 and magnet layers 3 are preferably housed within a hollow tube casing which includes an outer cylindrical housing 4, an inner cylindrical housing 5, and an empty center. The locations of the flux return are shown as gray flux lines in FIG. 1. The drum homopolar machine 1 preferably further includes connectors/wires 6 which are electrically hard connected (e.g., fixedly connected as opposed to sliding connected) to the rotors through, for example, welding, brazing, etc. The connectors/wires 6 are structured to pass through the empty center to connect one axial end of a first one of the rotors 2 to a far axial end of another one of the rotors to link them in series, parallel, or a combination of series and parallel. There are preferably disk-shaped end caps 7 (shown in FIGS. 2 and 3, for example) that connect the inner and outer yokes defined by the outer cylindrical housing 4 and the inner cylindrical housing 5 (not pictured in FIG. 1).

When this entire drum homopolar machine 1 is operated as a generator and spins axially the magnetic flux field generated by the magnet layers 3 does not rotate, but instead remains stationary. As the rotors rotate through this stationary radial flux field in the cylindrical body of the generator an emf is induced that causes a voltage pushing current towards one axial end of the rotors 2. A respective one of the wires/connectors 6 picks up the current from that end of the rotor 2, passing through the axial center of the machine 1 to connect with a different rotor layer 2 on the far axial end. But for a single problem, this would be an ideal way of connecting the rotors 2 in series to add the voltages. The problem comes from the wires/connectors 6 spinning with the rotor 2 and stator 3 components of the machine 1. As the wires 6 are dragged through the reverse flux field, an equal and opposite emf is induced in the wire 6 effectively canceling the net current flow from the additional rotor 2 (e.g., an output of one of the series connector rotors 2 will be opposite to that of another one of the series connector rotors 2).

The origin and insertion of each wire 6 is preferably at the rotor 2 in the center of the stator's 3 flux loops. The path that the wire 6 travels crosses the walls of that flux loop. Simply re-routing the wire cannot solve this problem. There is no alternative path for the wire 6 that does not cross the flux box walls (discussed in more detail below) that surround the origins and insertions of the wire 6 at the axial ends of the rotors 2.

The problem can be understood as below. The connectors/wires 6 connect to the ends of the rotor 2 in an area that is inside the closed loops of the flux path. The wires 6 course through the flux's return path to get to the other side of the rotors 2. There is no way to get from inside one flux box to the inside of the other flux box without crossing the walls of each box.

Note that in FIG. 1, the inner magnets of the inner stator 3 layers should be stronger than the outer stator 3 layers in proportion to their circumference such that the inner flux return yoke (e.g., the inner flux return yoke defined by the inner cylindrical housing 5) should be thicker and or more permeable than the outer flux return yoke (e.g., the outer flux return yoke defined by the outer cylindrical housing 4) in the same ratio.

FIG. 2 shows an example embodiment of the present invention which has a cylindrical structure and includes flux paths FP (emphasized at the bottom of FIG. 2) that define two taurus shaped closed ‘boxes’. The wires 6 preferably connect the rotor layers 2 in series. The wires 6 pass from within the center of one side's flux path box, coursing through walls of both of the 2 flux boxes to get to the center of the other flux box. The problem area is depicted where the wires cross the flux lines at points “X”. Each time the wire 6 transects the return flux path, it experiences an opposite voltage induction in the wire 6 which cancels out the addition of half of an additional rotor's 2 voltage. Because the wire 6 transverses two walls of the flux boxes, the entire voltage of the additional rotor 2 is effectively canceled.

Described below are a variety of solutions provided by example embodiments of the present invention that offer different efficacy in solving the above-discussed problems with flux return. The following variety of solutions provided by example embodiments of the present invention can be combined and altered to adapt to other homopolar configurations without losing the core idea.

### 1. “Flux Bearing”

At the point where the wires/connectors 6 transect the flux return, a flux return mitigation assembly includes series of paired individual axial or diametric magnets (A) create an inter-magnet field in a gap (B). The inter-magnet field in the gap (B) rotates with the device 1 and wire/connectors 6 and provides a path through the flux of the circumferentially adjacent magnets 3 because the magnets (A) provide a distinct field which is distinct from that of the circumferentially adjacent magnets 3. The wires/connectors 6 do not experience transecting flux because they rotate with these individual moving fields. The north-south axes of the individual magnets (A) are oriented such that the anti-gap side flux from those individual magnets (A) pairs with the stationary paradox field from the stators 3 where the magnets (A) attach to a flux return yoke defined by the disk-shaped end caps 7, the inner cylindrical housing 5, and the outer cylindrical housing 4. The flux pairing is magnetically analogous to an electrical sliding contact as the moving field from the individual magnets (A) can slide along the stationary Faraday paradox vector field in the yoke while the field on the gap side rotates with the machine 1. The net result is that the flux return in the yoke remains a stationary paradox field, but the segment of the flux return between the magnets (A) rotates with the device.

Therefore, the wire/connectors 6 do not transect the flux and do not experience EMF induction. The individual magnets (A) need to be sized and of sufficient strength to provide sufficient flux to pair with all the available return flux in the corresponding area of yoke so that left over return flux does not push through the individual magnets (A) rather than all of it pairing with the magnet's intrinsic flux.

The magnets not near the wire can be contiguous rather than having a gap. For these descriptions of novel solutions, the inner yoke is divided. It could be the outer yoke or side walls.

### 2. “Flux Invisibility Cloak”

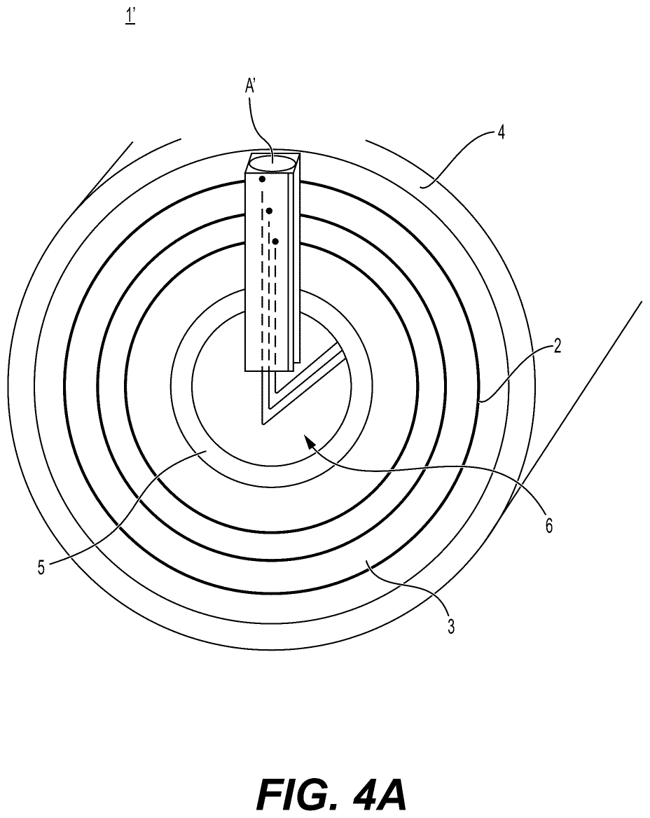

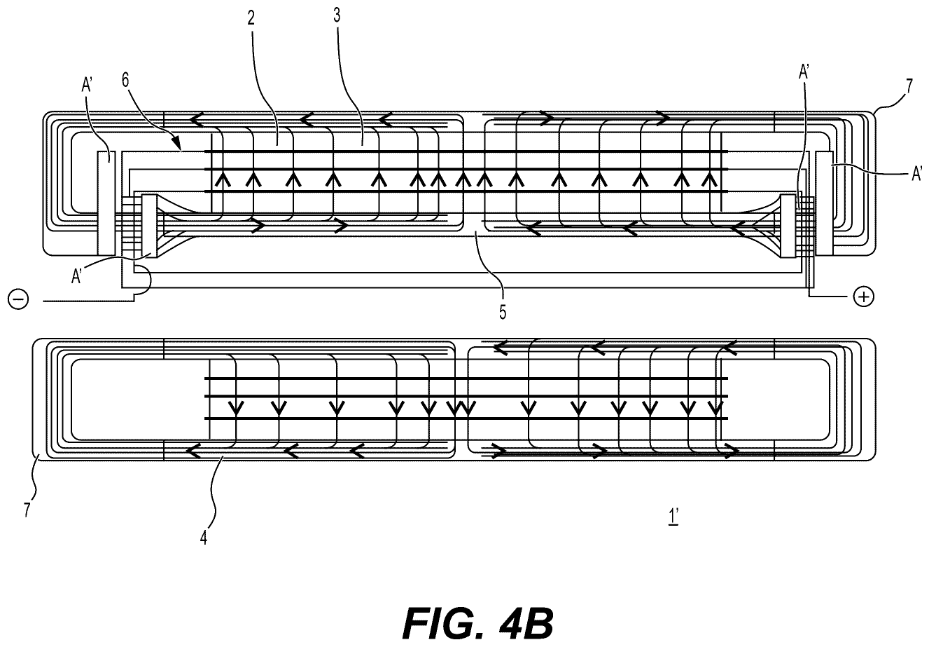

Here, as shown in FIGS. 4a and 4b, the electrical connections 6 are sandwiched between two individual paired magnets (A′) that rotate with the connectors 6 and the device 1′, the two individual paired magnets (A′) preferably being provided at a single circumferential portion of the device 1′. The inner field between the individual magnets A′ rotates with the electrical connectors. The outer side individual magnet flux pairs with the return flux. With this arrangement, the wire/connectors 6 do not transect the flux and do not experience EMF induction.

Alternatively, the shielding magnets (A′) could be put in with reversed polarity. The shielding magnet (A′) flux field would not pair with stator magnets'3 return flux. In this orientation the shielding magnets'(A′) flux would repel the stators'3 return flux to course around the rotor 2 connectors.

### 3. “flux Bearing in a Dual Generator”

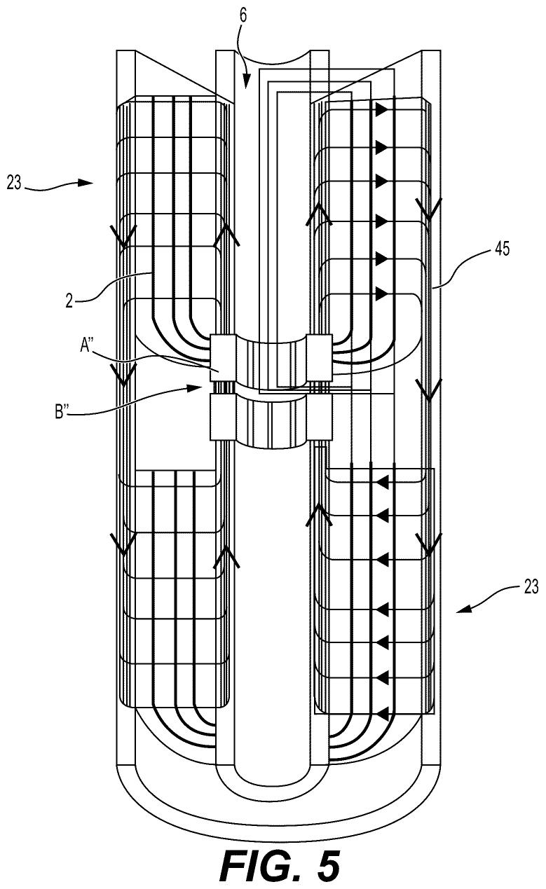

FIG. 5 depicts alternative configurations of the above example embodiments. The wiring in FIG. 5 is slightly imperfect. Specifically, while there are many possible ways to wire the layers and stacks together, having the rotors 2 of each stack joined in series, and having the stacks themselves wired in series would give the highest voltages.

In FIG. 5, two cylindrical stacks 23 of layered rotor 2/magnet 3 layers are depicted. The rotor layers 2 and the cylindrical magnets 3 are preferably arranged in a radial orientation and affixed to one another.

The solutions for connecting the rotors also apply to permutations described in U.S. Provisional Patent Application 63/659,440, incorporated herein by reference in its entirety, wherein the conductive layers and magnet layers are combined into single layers that are stacked with other such layers concentrically, but with electrical insulation between the layers. As well, these solutions apply to the structures described in all the inventor's related generator/motor patents.

The cylindrical concentrically nested rotor/magnet ‘stacks’23 described in this example embodiment are adjacent in the same external flux return cylindrical yoke housing 45. In this example embodiment, the stack 23 on the top has the north side of the magnets facing outward, and in the bottom side stack, the north sides are facing centrally. The stacks could be the other way around as long as the polarity is reversed between the stacks.

There are also example embodiments with more than two stacks. In a two stack example, the EMF in the rotors 2 is either directed in opposite directions because the rotor flux is directed in opposite radial directions. Depending on the direction of spin, the stacks 23 would produce emf that pushes in opposite directions-laterally or medially depending on the direction of spin. Each stack 23 is part of the flux return for the other stack. Each stack 23 contributes extra flux to the other. The inner yoke flux return of the housing 45 is separated into 2 adjacent cylinders. In the space between the medial ends of the 2 inner flux return cylinders 2 rings of permanent magnets (A″) that are affixed to their respective tubes. These individual magnets (A″) are oriented such that the flux on their lateral surfaces pairs with the stationary field in the inner yoke. Opposite poles of the magnets (A″) oppose each other across a gap (B″) through which the electrical connectors 6 pass. The gap (B″) can be between one lateral pair of magnets (A″). The other lateral magnet pairs can touch longitudinally or be one or more magnets stacked north to south. The wires could also pass through a hole in a magnet (A″). The field in this place the wires 6 pass rotate with the machine. The fields in the laterally paired magnets (A″) rotate with the machine. A side benefit is that the individual magnets (A″) contribute more flux to the circuit.

### 4. “Crown Inner Yoke”

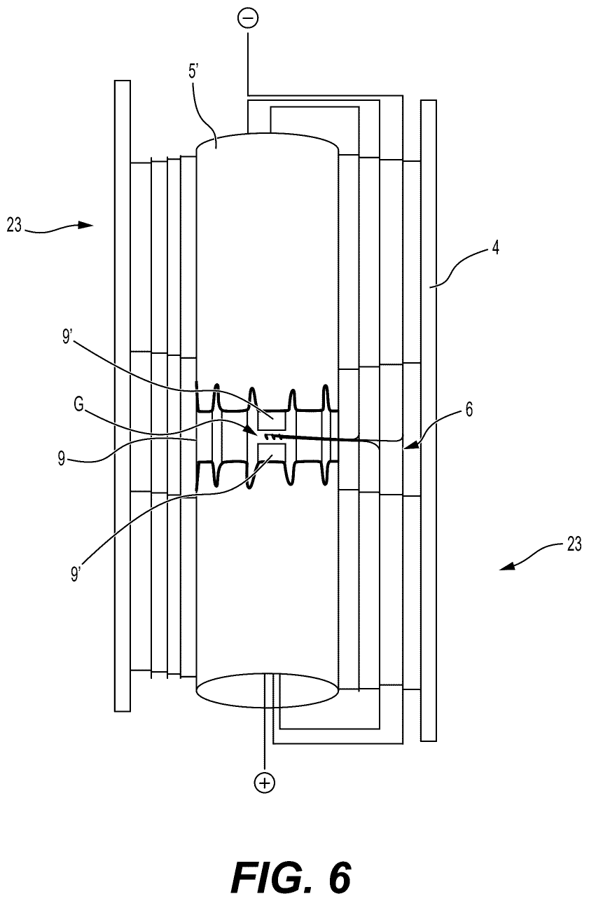

FIG. 6 shows an alternate example embodiment showing the inner yoke 5′ flux returns slotted medially at axial ends to divide the flux. The space between the inner yokes 5′ is bridged by individual magnets 9 oriented such that they pair with the flux from the cylindrical yoke sections literally and creating discrete flux bridges between them. In this case, the wires come through a gap (G) between two fractional magnets 9′. Having them travel in the spaces between lateral magnets or through holes in the magnets is considered in all of these solutions.

### 5. “Rotating Radial Endcaps”

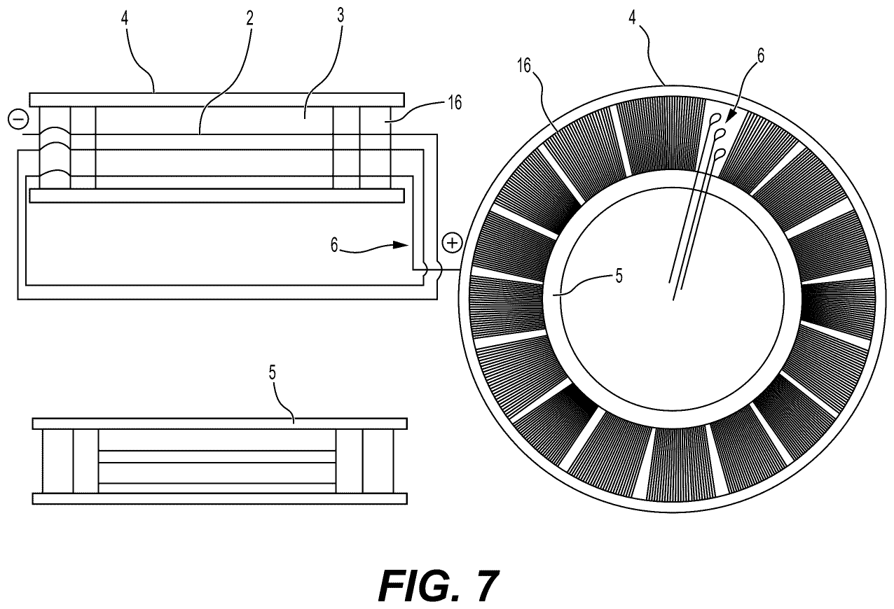

FIG. 7 shows a side view cross section and axial end on views of an alternative example embodiment of the present invention. This example embodiment makes the return flux passing through the end caps rotate by utilizing radial magnets 16 that are discrete assemblies and connect the inner yoke 5 and outer yoke 4.

In this example embodiment, instead of monolithic disks as end cap yokes, wedge shaped individual magnets 16 are preferably used, for example. On the periphery, the magnets 16 pair with the flux in the outer yoke 4 and in the center they pair with the cylindrical inner yoke 5 to provide a flux return path that rotates at the axial end. As long as the radial magnets 16 supply at least as much flux as the cylindrical yokes 4 and 5 deliver, the wires pass through the end caps relatively unmolested by a paradox field.

An enhancement would be to include parametric shielding with materials such as, for example, bismuth and/or pyrolytic carbon around the wire 6 at the level at which it crosses the flux.

### 6. ‘Flux Plugs’

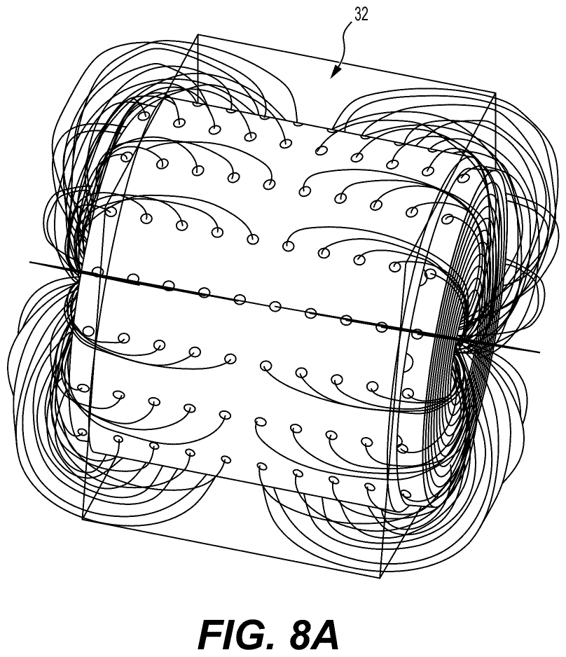

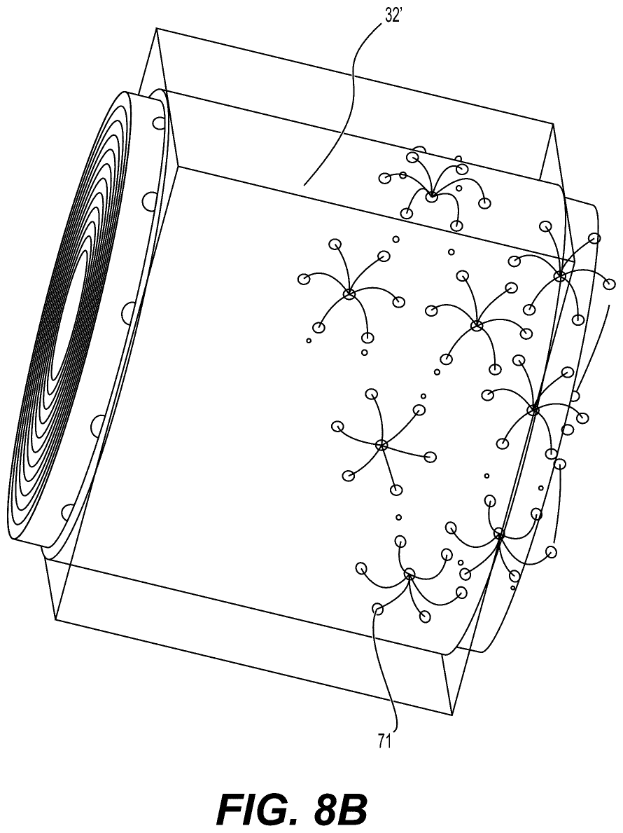

FIGS. 8a and 8b show additional example embodiments of rotor-stator stacks according to an example embodiment of the present invention. FIG. 8a shows a return flux field that forms around the rotor-stator stack 32. Traditionally, the generator is encased in a yoke that contains this return flux and generally mimics its path. In FIG. 8b, holes 71 have been drilled or otherwise formed radially through the cylindrical layers of a rotor-stator stack 32 to provide a series of alternate internal flux return paths having, for example, starburst shapes. The holes 71 would not be not confined to one section of the rotor-stator stack 32 as is shown in FIG. 8b for simplicity. The holes 71 can be filled with plugs made of a material of suitable permeability and saturation to pull the return flux away from the axial ends such as iron, for example. The material of suitable permeability can also be cylindrical magnets with reverse polarity from the stator magnets. They need to be electrically isolated from the rotors. Configurations such as this move the return flux away from the axial ends of the rotors 2 where the connectors pass. The plugs can be layered with more permeable material toward the center to reduce lateral flux interactions.

Minimally effective additional solutions include alternative wire routes including drilling the wire path down through the magnets near the edge instead of routing the wires at the space next to the rotors'ends, traditional shielding of the wires/connectors against the flux field, and using diametric, axial or otherwise magnetized stacked ring or cylinder magnets as passive shielding around the wire would largely only be sufficient if the wire was oriented parallel to the flux field. When the wire's course cuts the field lines, shielding around the wire is not effective because the flux line would have to break to allow the wire to pass through it without creating EMF, which is not realistic.

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A homopolar dynamoelectric machine comprising:
a hollow tube with an empty center;
stator layers spaced radially apart from one another and housed within the hollow tube;
rotor layers provided within the hollow tube alternating between adjacent ones of the stator layers and rotatable due to a magnetic field generated by the stator layers;
electrical connectors which electrically connect axial ends of adjacent ones of the rotor layers in series, parallel, or a combination of series and parallel; and
at least one flux return mitigation assembly that interacts with flux of the magnetic field generated by the stator layers; wherein
the rotor layers and the stator layers are integrally connected to be rotatable together about a central axis of the hollow tube.

2. The homopolar dynamoelectric machine according to claim 1, wherein the electrical connectors pass through the empty center.

3. The homopolar dynamoelectric machine according to claim 1, wherein the at least one flux return mitigation assembly includes a series of paired individual axial or diametric magnets which are spaced apart to create an inter-magnet field in a gap between the series of paired individual axial or diametric magnets.

4. The homopolar dynamoelectric machine according to claim 3, wherein the series of paired individual axial or diametric magnets are provided on both of the hollow tube and a disk-shaped end cap covering an axial end of the hollow tube.

5. The homopolar dynamoelectric machine according to claim 1, wherein the at least one flux return mitigation assembly includes two individual paired magnets rotatable together with the electrical connectors, the electrical connectors passing through a gap between the two individual paired magnets.

6. The homopolar dynamoelectric machine according to claim 1, wherein the at least one flux return mitigation assembly includes two of the at least one flux return mitigation assemblies located on opposing axial ends of the homopolar dynamoelectric machine.

7. The homopolar dynamoelectric machine according to claim 1, wherein
the stator layers and the rotor layers define two cylindrical stacks of layered rotor and stator layers which are spaced apart axially; and
the at least one flux return mitigation assembly is located axially between the two cylindrical stacks of layered rotor and stator layers.

8. The homopolar dynamoelectric machine according to claim 7, wherein
the at least one flux return mitigation assembly includes slotted flux returns at axial ends of opposing portions of the hollow tube.

9. The homopolar dynamoelectric machine according to claim 8, wherein
the slotted flux returns are connected to individual magnets oriented to create discrete flux bridges therebetween.

10. The homopolar dynamoelectric machine according to claim 9, wherein
the individual magnets include a pair of fractional magnets defining a space through which the electrical connectors pass.

11. The homopolar dynamoelectric machine according to claim 1, wherein
the at least one flux return mitigation assembly includes radial magnets provided at opposing axial ends of the hollow tube.

12. The homopolar dynamoelectric machine according to claim 1, wherein
the stator layers include permanent magnets to generate a fixed magnetic field; and
the rotor layers include conductive portions that are rotatable through the fixed magnetic field to produce an electric current.

13. The homopolar dynamoelectric machine according to claim 12, wherein the stator layers and the rotor layers define a cylindrical stack of layered rotor and stator layers, with holes passing radially through the cylindrical stack to provide a series of alternate internal flux return paths.

14. The homopolar dynamoelectric machine according to claim 1, wherein the stator layers are fixed to the rotor layers with electrically insulating material provided therebetween.

15. The homopolar dynamoelectric machine according to claim 1, wherein a radially inner one of the stator layers has stronger magnetic properties than a radially outer one of the stator layers.
